(19) United States
(12) Patent Application Publication
(10) Pub. No.: US 2017/0083925 A1
(43) Pub. Date: Mar. 23, 2017

(54) Systems, Methods, Apparatus, and Computer-Readable Media for College Rating Using Consumer Purchase Transaction Data

(71) Applicant: MasterCard International Incorporated, Purchase, NY (US)

(72) Inventors: Qian Wang, Ridgefield, CT (US); Tong Zhang, Fort Lee, NJ (US); Edward Lee, Scarsdale, NY (US)

(21) Appl. No.: 14/859,037

(22) Filed: Sep. 18, 2015

(51) Int. Cl. G06Q 30/02

(52) U.S. Cl. CPC G06Q 30/0201

(57) ABSTRACT

Systems, methods, apparatus, and computer-readable media are described herein for using data from recent consumer purchase transactions to indicate a comparative level of current interest for each among a number of colleges.

### BACKGROUND

Field of the Disclosure

Aspects of this disclosure relate in general to systems and methods for rating and comparing colleges.

Description of the Related Art

It has been noted that for most students and their families, selecting a college is one of the biggest financial decisions they will make. Moreover, once a student has decided to attend a particular college, the decision is difficult to reverse and will typically have a large effect on the future course of the student's life.

To assist in this decision, organizations such as U.S. News and World Report, Forbes, The Princeton Review, and the National Center for Education Statistics publish college rankings every year. These ratings are based on factors such as widely accepted indicators of academic excellence (e.g., freshman retention rate, graduation rate, the strength of the faculty), acceptance rate, growth in admissions applications, student satisfaction, student debt, and the like. However, as these rankings are calculated from historical data, they are often outdated by the time they are published.

### SUMMARY

A method, according to a general configuration, of using data from recent purchase transactions to indicate a comparative level of current interest for each among a number of colleges is described. This method includes identifying, from among a plurality of records of consumer purchase transactions, and for each of a plurality of colleges, records that are associated with the college. This method also includes calculating, for each of the plurality of colleges, and for each of a plurality of interest indicators, a value of said interest indicator for the college, wherein said value is based on information from the records identified for the college. This method also includes producing, for each of the plurality of colleges, an index value for the college that is based on (A) the calculated at least one interest indicator value for the college and (B) the calculated at least one interest indicator value for each of at least one other college among the plurality of colleges. This method also includes, subsequent to said producing, transmitting an indication relating to at least one of the produced index values. Systems and apparatus configured to perform such a method are also disclosed. Computer-readable storage media (e.g., non-transitory media) having instructions that cause one or more processors executing the instructions to perform such a method are also disclosed.

An apparatus, according to a general configuration, for using data from recent purchase transactions to indicate a comparative level of current interest for each among a number of colleges is described. This apparatus includes a transaction database configured to store a plurality of records of consumer purchase transactions; a search interface configured to identify, from among the plurality of records of consumer purchase transactions, and for each of a plurality of colleges, records that are associated with the college; an indicator calculator configured to calculate, for each of the plurality of colleges, and for each of a plurality of interest indicators, a value of said interest indicator for the college, wherein said value is based on information from the records identified for the college; and an index calculator configured to produce, for each of the plurality of colleges, an index value for the college that is based on (A) the calculated at least one interest indicator value for the college and (B) the calculated at least one interest indicator value for each of at least one other college among the plurality of colleges. This apparatus also includes a communication module configured to transmit an indication relating to at least one of the produced index values.

A non-transitory computer-readable medium, according to a general configuration, for using data from recent purchase transactions to indicate a comparative level of current interest for each among a number of colleges is described. The medium is encoded with data and instructions, and when executed by at least one processor the instructions cause the at least one processor to identify, from among a plurality of records of consumer purchase transactions, and for each of a plurality of colleges, records that are associated with the college; calculate, for each of the plurality of colleges, and for each of a plurality of interest indicators, a value of said interest indicator for the college, wherein said value is based on information from the records identified for the college; produce, for each of the plurality of colleges, an index value for the college that is based on (A) the calculated at least one interest indicator value for the college and (B) the calculated at least one interest indicator value for each of at least one other college among the plurality of colleges; and, subsequent to said producing, transmit an indication relating to at least one of the produced index values.

### BRIEF DESCRIPTION OF THE DRAWINGS

FIG. 1A shows a division of a calendar year into different phases of a season of one example of a college expense cycle.

FIG. 1B shows a season of one example of a college expense cycle.

FIG. 2 shows a flowchart of a method M100 of using data from recent purchase transactions to indicate a comparative level of current interest for each among a number of colleges.

FIG. 3A shows one example of producing an index value for each college in a desired group.

FIG. 3B shows one example of producing an index value for each group of colleges in a comparison among selected groups.

FIG. 4A shows a block diagram of an apparatus A100 for using data from recent purchase transactions to indicate a comparative level of current interest for each among a number of colleges.

FIG. 4B shows a block diagram of a system implementation of apparatus A100.

### DETAILED DESCRIPTION

Systems, methods, and apparatus as described herein may be used to produce a live index of colleges, based on information from credit card transactions, that reflects the popularity of each college over time, especially during the admission phase of an annual cycle. In contrast to previous college ranking methodologies, such an index is based on activity of the current year and may be seen as a comparative indication of the college's current popularity.

As used herein and/or in the claims appended below, the term “college” means a post-secondary (tertiary) undergraduate educational institution. Some such institutions may also be known by other terms, including but not limited to “university” (as in Boston University) and “institute” (as in Massachusetts Institute of Technology). It will be understood that the systems, methods, and apparatus described herein may similarly be used, additionally or in the alternative, for other educational institutions, including but not limited to institutions for vocational education; postgraduate educational institutions; private pre-school, primary, or secondary educational institutions; etc.

As used herein and/or in the claims appended below, the term “payment network” means a system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard International Incorporated of Purchase, N.Y.

As used herein and/or in the claims appended below, the term “payment account” means a financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual.

As used herein and/or in the claims appended below, the term “payment card organization” means an entity that sets the standards and provides the mechanism for effectuating payment between a purchaser and a merchant in a payment card transaction. A payment card organization generally provides the payment mechanism by issuing payment cards, enrolling merchants as authorized acceptors of payment cards for payment for goods or services, and ensuring the system conducts the transactions in accordance with prescribed standards.

As used herein and/or in the claims appended below, the term “payment card” means a card (or an account) issued by a payment card organization to a cardholder/payor, which upon presentation to a merchant/payee, represents an agreement of the cardholder to pay the merchant through the payment card organization. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or other computer). For example, in some instances, data including or indicating a payment account number (e.g., a token, as may be generated by host card emulation (HCE)) may be considered a payment card for the processing of a transaction funded by the associated payment account.

As used herein and/or in the claims appended below, the term “payment card transaction” means a transaction in which a cardholder/payor uses a payment card to purchase goods or services, and a merchant agrees to accept a payment card as a means of obtaining payment. A “consumer purchase transaction” is a payment card transaction in which the payor account is issued to a consumer rather than to a business.

The expenses relating to the college admission application process that are incurred by prospective students may be associated with different time stages or phases of an annual “college expense cycle”:

1) expenses related to visits to the college campus by prospective students;

2) fees for standardized college admission examinations and for forwarding of examination scores to the college;

3) fees for applications for admission to the college; and

4) payment of admissions deposits (also called “enrollment deposits”) to the college.

These expenses do not necessarily occur in chronological order, as for any particular student, one phase may overlap with another, and the actual expense cycle for a particular student may be greater than one year. For example, a student may take the SAT for the first time in late spring of junior year and apply for admission to a college in early spring of senior year. Nevertheless, in the aggregate it is useful to consider this cycle as having an annual period (or season).

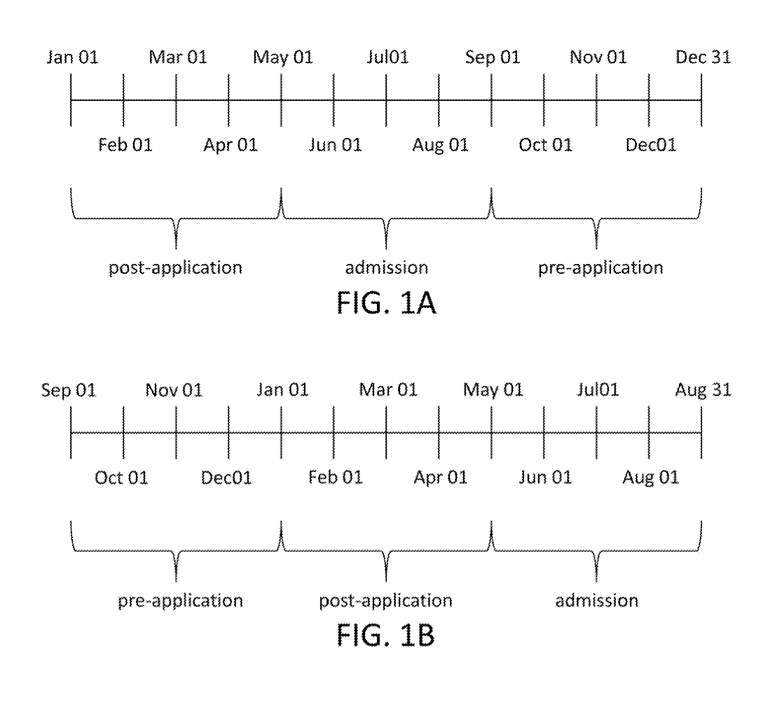

FIG. 1A shows a division of a calendar year into different phases of a season of one example of such a college expense cycle. For the same example of a college expense cycle, FIG. 1B shows one season of the cycle, beginning with the pre-application phase, followed by the post-application phase, and ending with the admission phase.

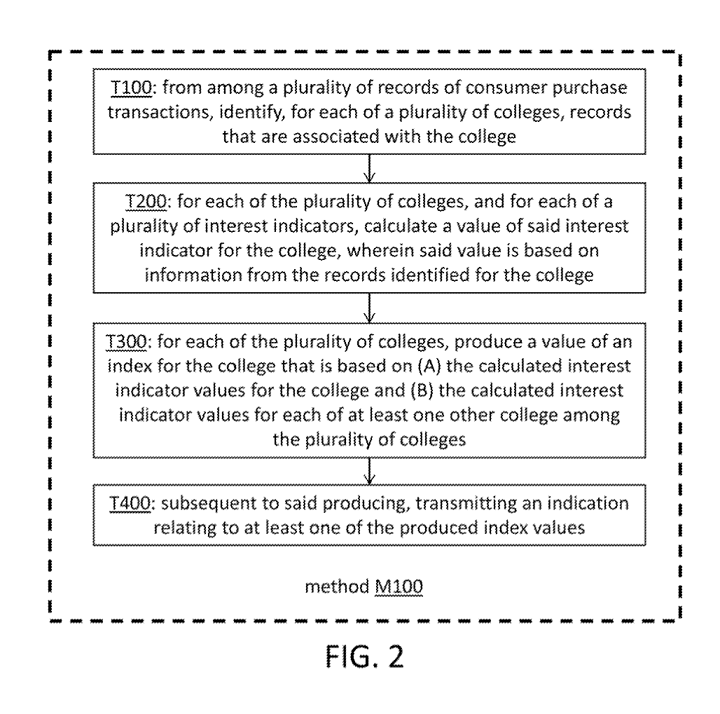

FIG. 2 shows a flowchart of a method M100, according to a general configuration, of using data from recent purchase transactions to indicate a comparative level of current interest for each among a number of colleges. Method M100 includes tasks T100, T200, and T300. From among a plurality of records of consumer purchase transactions, task T100 identifies, for each of a plurality of colleges, records that are associated with the college. For each of the plurality of colleges, and for each of a plurality of interest indicators, task T200 calculates a value of the interest indicator for the college. For each interest indicator, this value is based on information from the records identified for the college. For each of the plurality of colleges, task T300 produces an index value for the college that is based on (A) the calculated at least one interest indicator value for the college and (B) the calculated at least one interest indicator value for each of at least one other college among the plurality of colleges. Subsequent to task T300, task T400 transmits an indication relating to at least one of the produced index values.

From among a plurality of records of consumer purchase transactions, task T100 identifies, for each of a plurality of colleges, records that are associated with the college. A record of a consumer purchase transaction may include, for example, fields for any one or more of the following data items: an account identifier, a merchant identifier, a date, a time of day, a payment amount, and a payment description. Typically, a record of a consumer purchase transaction will include all of these data items. Such a record may also include any other type of transaction information (e.g., merchant geolocation, cardholder zip code, cardholder spend profile), which may be part of the record when it is created or may be added later.

In some cases, a record of a consumer purchase transaction may be associated with a college because the college is identified as the merchant. In other cases, a record of a consumer purchase transaction may be associated with a college by identification of the college in addendum data of the purchase transaction (e.g., a purchase from a third-party academic merchant, such as a test provider or application processor). In further cases, a record of a consumer purchase transaction may be associated with a college by geographical proximity of the merchant to the college and possibly also based on a date of the transaction.

One example of a merchant identifier is a four-digit Merchant Category Code (MCC). The MCC is a classification code that is assigned by a payment card organization to a merchant/payee. The payment card organization assigns the merchant a particular code based on the predominant business activity of the merchant. The MCC is used by payment card organizations, including MasterCard International Incorporated, and is recognized by the Internal Revenue Service. It is expressly noted that the principles described herein are also applicable to the use, whether additionally or in the alternative, of analogous classification systems, such as the Transaction Category Code (TCC, a one-letter code by MasterCard™), the Standard Industrial Classification (SIC, a four-digit code), and the North American Industry Classification System (NAICS, a six-digit code).

Task T100 may examine a merchant identifier portion of a consumer purchase transaction record to identify consumer purchase transactions with academic merchants. Records of purchase transactions in which a college itself is the merchant may be indicated, for example, by the MCC “8220” and/or the TCC “O”. Relevant purchase transactions in which a college is the merchant may include, for example, application fees and admissions deposits.

A social segment associated with the cardholder of a particular purchase transaction may be inferred, for example, by clustering card accounts according to spend pattern. Examples of spend patterns include “affluent”, “empty-nesters”, and “travelers”. Such information may be useful, for example, for providing a measure of interest for a college for a particular social segment. In one example, it may be expected that activity by a cardholder in a high-spending cluster will be more closely correlated with an Ivy League college.

For each of the plurality of colleges, and for each of a plurality of interest indicators, task T200 calculates a value of the interest indicator for the college, wherein this value is based on information from the records identified for the college.

A prospective student may first indicate interest in attending a particular college by visiting the campus. The first stage of the “college expense cycle” includes expenses associated with campus tours, road trips, and other visits to the college by prospective enrollees. The season for such visits typically begins in late summer and may continue into the winter.

Such visits may be indicated by purchases at the campus store or stores. Measures of such purchases may include an aggregate amount (e.g., a sales index) or number of unique customers (e.g., a customer count index). In calculating such a measure, it may be desired to filter out purchase transactions that were more likely made by enrolled students (e.g., textbooks) so that the measure may be based instead on purchase transactions that were more likely made by visitors. For example, visitors may be more likely to purchase apparel (e.g., T-shirts, sweatshirts), mugs, and other items that may bear the college's insignia. A desire to wear the college's insignia may be a good indicator of the college's popularity, and in any case such a purchase would be a strong indicator of interest in the college.

Records of such purchase transactions may be identified by searching for the name (or other identifying label) of the college, or of the authorized operator of the campus store, in the merchant identifier field of the record. Additionally or in the alternative, records of such purchase transactions may be identified indirectly using knowledge of the purchaser's spend pattern and geography. For example, a unique visit by a cardholder to the college town (e.g., as indicated by purchases of gasoline, restaurant meals, and/or lodging) that occurs in the fall may indicate a visit by a prospective student, especially if the cardholder's account is associated with a family spend profile and/or shows similar visits to one or more other college towns during the same period.

Visits by prospective students to a college campus may also be inferred from records of consumer purchase transactions with merchants that are located in the college town, or otherwise are in geographical proximity to the college, and which occur during times associated with campus visits (e.g., from late summer through winter). Purchases that indicate a campus visit may include, for example, lodging and meals at restaurants. Records of consumer purchase transactions for lodging may be identified by a merchant category code (MCC) in the range 3501-3790 and/or a Transaction Category Code (TCC) of “H”. Records of consumer purchase transactions for restaurant meals may be identified by a merchant category code (MCC) of “5812” or “5814” and/or a Transaction Category Code (TCC) of “F”.

It may be desired to refine such a measure of local merchant activity to account for activity that is not related to campus visits. For example, a measure based on consumer purchases of lodging may be filtered to remove records associated with purchasers that are repeat customers, as such records may indicate returning students or business travellers rather than prospective students. Additionally or in the alternative, it may be desired to refine a measure of local merchant activity by normalizing it with an indication (e.g., month-to-month or year-to-year) of overall local economic activity due to the resident population. Such an indication may be based, for example, on an aggregate amount of purchase transactions at local home improvement stores.

The second stage of the “college expense cycle” includes fees paid by prospective college students to providers of standardized college admission examinations for examination fees and for delivery of the resulting examination scores to one or more selected colleges. One such provider is the College Board, which administers the Scholastic Aptitude Test (SAT). Another such provider is ACT, Inc, which administers the ACT college readiness assessment examination. It is customary for a student to take such an examination in the spring semester of junior year and again in the fall semester of senior year, with registration and payment being due about one month to six weeks before the test date (or later, with payment of a late fee).

Records of such purchase transactions may be identified by searching for the name (or other identifying label) of a test provider (e.g., College Board or ACT, Inc.) in the merchant identifier field of the record. Association of such a record with a particular college may be identified in addendum data of the record, especially if an additional fee was paid for forwarding the test score to that college. Aggregate data from these merchants (e.g., total number of such purchase transactions over a period, cumulative total number of such purchase transactions for the season) may be used to establish an indicator of an overall level of interest for the current year that may also be refined using one or more factors, such as geographical region, income bracket, etc. For example, information from such purchase transactions (e.g., transaction date, consumer geographical location, consumer spend profile) may be used to provide an indication of the size and distribution (e.g., geographical and/or social) of the current season's applicant pool. Such an indication may be used as a baseline (e.g., a normalizing factor) when calculating index values for individual colleges as described herein.

The third stage of the “college expense cycle” includes fees paid by prospective college students for applications for admission to the college. Such fees may be paid to the college as merchant and/or to a third-party application provider (e.g., The Common Application, Arlington, Va.) as merchant. In the latter case, the one or more particular colleges to which the application is to be submitted may be identified in addendum data of the purchase transaction record. The application deadlines for regular admission typically fall within the range of January 1 to March 1, with deadlines for early decision and early action being about three months and two months earlier, respectively.

The fourth stage of the “college expense cycle” includes fees paid by accepted applicants, to the college as merchant, for admissions deposits. Colleges typically notify candidates of their acceptance between April 1 and May 1, with payment of the deposit being due soon afterward.

Records of purchase transactions for application fees and admissions deposits may typically be distinguished from records of other consumer fees paid to the college (e.g., for tuition) by their timing and/or amount, as application fees and admissions deposits are both usually amounts that are fixed for the particular college and paid during a particular narrow time interval. College application fees are typically in the range of twenty-five to ninety dollars, and admissions deposits (also called “enrollment deposits”) are typically in the range of two hundred to five hundred dollars.

Other measures of interest in a college may be obtained from public data. In one example, the college itself may provide an enrollment profile indicating such measures as acceptance rate, number of admitted applicants, geographic profile of the student body, etc. A high school website may indicate such measures of interest as, for at least one college, the number of students who have been admitted to and/or have enrolled in the college. Such information may also be weighted by a graduation rate of the high school. An association between a college and a high school may be determined and/or weighted by the distance from the high school to the college.

Other such public data may include demographics, such as census data. Measures of interest in a college that are obtained from public data typically have a longer cycle and are more historical than the purchase-transaction-based measures discussed above.

Other measures of interest in a college may be obtained from social networking websites, such as Facebook, Yik Yak, Reddit, Instagram, Foursquare, Quora, etc. Such a measure (e.g., a number of mentions of the college, a ratio of positive to negative mentions of the college, etc.) may be obtained using a social media data acquisition service, typically through an application programming interface (API) of the social networking website.

As described above, measures of interest in a college may include any of the following: number of campus visits to the college, number of test scores forwarded to the college, number of applications for admission to the college, number of deposits paid to the college, number of mentions of the college on social media, number of mentions of the college on high school websites. In some cases, an activity may be associated with more than one measure of interest, any one or more of which may be used in a particular implementation of task T200. For example, activity relating to campus visits may be quantified as a measure of gross dollar value (sales index) and/or as a measure of the number of unique customers (customer count index).

For any particular measure of interest, task T200 may be implemented to calculate the value of a corresponding interest indicator as the total amount of the measure over a selected time period (e.g., weekly, monthly, cumulative for the season). Alternatively, task T200 may be implemented to calculate the value of the interest indicator as a relation between such a total amount of the measure for a current period relative to the total amount of the measure for a previous period (e.g., the previous week, the previous month, cumulative for last season at this time). In a further alternative, task T200 may be implemented to calculate the value of the interest indicator as a weighted average of more than one historical value of the measure (e.g., mean of last two years, ⅔ of last year+⅓ of previous year, etc.). Task T200 may also be implemented to calculate the values of two or more interest indicators as such alternatives from a single measure of interest.

For a case in which a particular interest indicator is not available for a college, task T200 may be implemented to use an average value of the indicator from other colleges (e.g., the colleges within an identified peer group of the college), a value of zero, or another value as desired.

Task T200 may be implemented to calculate an interest indicator from values of two or more different measures of interest. For example, the number of test scores forwarded to a college may be combined with the number of applications for admission to the college to produce, as an interest indicator, an estimated percentage of test score forwards that were converted to applications. Similarly, a change over time in the size of the applicant pool (e.g., as indicated by a year-to-year change in the total number of recorded purchases of college admission examination fees, or such total number for a relevant social and/or geographical segment) may be used to normalize an interest indicator whose value is a change over time in the number of applications for admission to the college.

For each of the plurality of colleges, task T300 produces an index value for the college that is based on (A) the calculated interest indicator values for the college and (B) the calculated interest indicator values for each of at least one other college among the plurality of colleges. For example, task T300 may be implemented to produce the index value for a college based on interest indicator values for colleges within an identified peer group of the college. Such a peer group may be a collegiate athletic conference. Examples of such a conference include the Big Ten, the Ivy League, and other National Collegiate Athletic Association (NCAA) conferences. Other groupings of colleges that may be used include groupings by geographical region, by size (e.g., colleges whose total number of students falls within a particular size range), by social distribution (e.g., colleges whose student bodies have similar distributions across two or more social segments, colleges having a concentration of a particular social segment that is greater than (alternatively, not less than) a threshold value), etc. Task T300 may be implemented to produce corresponding index values for a college for any two or more such groupings.

Task T300 may be implemented to calculate a combined value of the calculated interest indicator values for a college and to produce an index value by comparing the combined values for each college in the desired group. In one example, task T300 is implemented to calculate the combined value as the sum of the calculated interest indicator values for the college. In another example, task T300 is implemented to calculate the combined value as a weighted average of the calculated interest indicator values for the college.

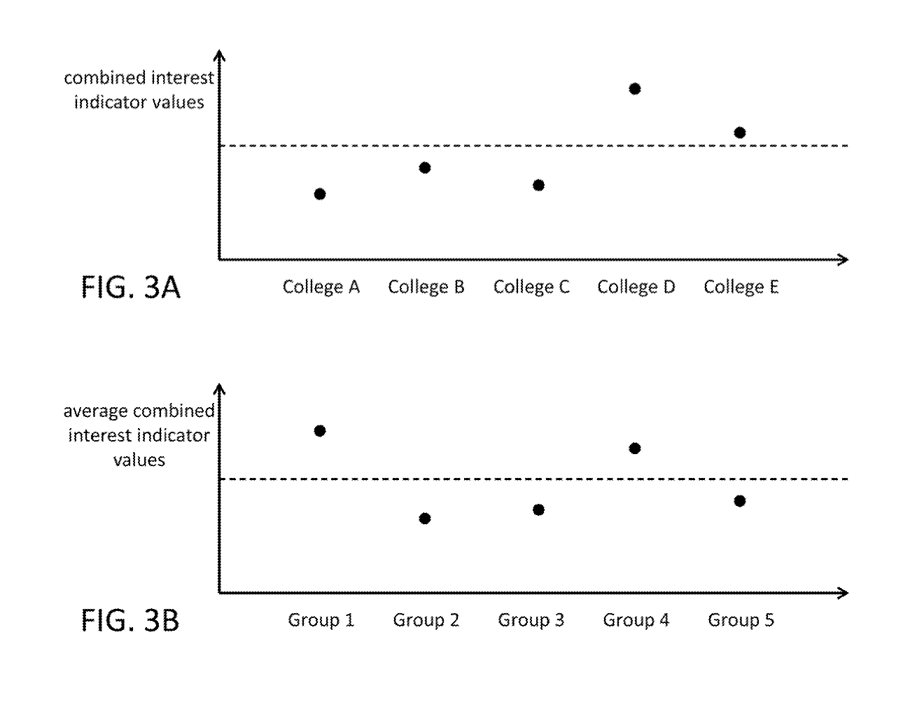

FIG. 3A shows one example of comparing the combined values for each college in a desired group. In this example, the dots indicate the combined values for each of the five colleges A-E in the group, and the dashed line indicates the mean of these combined values. In this case, task T300 may be implemented to produce the index value for each college as a ratio of the college's combined value to the mean. Alternatively, task T300 may be implemented to produce the index value for each college based on a percentage of deviation of the college's combined value from the mean.

Method M100 may be used to produce an annual index that is based on activity for the current year. Alternatively, as noted above, task T300 may be implemented to update the index values at least once during a college expense cycle. For example, it may be desired to implement task T300 to update the index values at least once during the pre-application phase, based on records of purchase transactions made during the intervening period. The period between such updates may typically range from one week to four months. In one such example, task T300 is configured to produce index values on or before October 1 and to produce updated index values on or before December 15. In another example, task T300 is configured to produce at least two different values of the index for a college during a pre-application period of October 1 to December 15.

Task T300 may be further implemented to produce, in a similar manner, an index value for each among two or more groups of colleges. Such index values may be used to indicate the comparative current popularities of the various selected groups. FIG. 3B shows such an example in which the dots indicate the average combined interest indicator values for each of the groups 1-5 (e.g., as shown by the dashed line in FIG. 3A) and the dashed line indicates the mean of these averages. As for the individual index values as described above, task T300 may be implemented to produce each group index value as a ratio of the group's average to the mean, or based on a percentage of deviation of the group's average from the mean.

Subsequent to task T300, task T400 transmits an indication relating to at least one of the produced index values. The indication may include a notification that such an index value has been produced. For example, the indication may be an alert that an index value has become available (e.g., at a website identified in the alert) for each of one or more of the plurality of colleges. Additionally or alternatively, task T400 may be implemented such that the indication includes the produced index value for each of one or more of the plurality of colleges.

Task T400 may transmit the indication within a printed document (e.g., via mail or other delivery service). Additionally or alternatively, task T400 may transmit the indication electronically, such as by e-mail and/or Short Message Service (SMS).

Task T400 may be implemented to transmit the indication to each destination (e.g., mailing address, e-mail address, and/or cell phone number of a person or organization) in a list of destinations. For example, task T400 may be implemented to transmit the indication to paid subscribers and/or persons who have otherwise pre-registered (e.g., to receive alerts). The destinations may include, for example, any of the following: the colleges for which task T300 has produced index values; other educational entities (e.g., high schools); prospective applicants; and merchants.

In a further example, task T400 may transmit the indication in response to a query, such as via SMS or over the Internet (e.g., via the Hypertext Transfer Protocol (HTTP) or another protocol). For a case in which task T400 is implemented to transmit one or more of the index values online (e.g., in response to a user entering a request at a website), it may be desired to restrict access to paid subscribers and/or persons who have otherwise pre-registered and whose access has been authenticated.

For a case in which task T300 is implemented to update the index values during a college expense cycle, task T400 may be implemented to transmit an indication relating to the update. Such an indication may include a notification that the updated index value has been produced. For example, the indication may be an alert that an updated index value has become available (e.g., at a website identified in the alert) for each of one or more of the plurality of colleges. Additionally or alternatively, such an indication may include the updated index value for each of one or more of the plurality of colleges.

Index values produced using an implementation of method M100 may be used for the benefit of the individual colleges. Colleges already typically utilize many different methods to find out more about the interests of their applicants, including college tour registrations, analysis of website visits, tracking of information session attendance, etc. However, it will benefit the college more to have an indication of their applicants' interest in other colleges. By aggregating “college expense cycle” transactions, an implementation of method M100 may be used to provide an index of the colleges that is based on a ratio of interest to each college relative to all interested colleges, by region and by one or more social segment. Providing a value of the index at different times (e.g., pre-application, post-application, admission) may also be performed to provide colleges with different guidance.

The index values produced using an implementation of method M100 may also be used for the benefit of applicants. For example, the index value for a particular college may be used by an applicant as an indicator of how competitive the admission process for the college will be during the coming year. Based on the index values for various colleges, the prospective student may predict whether she will have a better chance to be accepted by one college than another, and may find opportunities to game the admission process based on her own geographic and/or social segment.

The index values produced using an implementation of method M100 may also be used for the benefit of one or more elements of the local economy (e.g., merchants, taxing authorities, landlords, rental agencies). For example, changes in an index value over time may be used to analyze correlation of merchant sales and/or housing (e.g., rental) pricing with the “college expense cycle”. Index values produced using an implementation of method M100 may also be used to provide a forecast model for a college town merchant sales trend. Use of current transaction data allows implementations of method M100 to provide “flash reporting” and/or to support year-to-year trend analysis based on data from the current year. As indicators of comparative current popularity of colleges, such index values may be used by nationwide franchisees (e.g., McDonald's) for planning distribution.

The following example demonstrates a use of the index value for a college by the college itself and by a prospective student. In this example, College X is a member of the Big 10 athletic conference. The most recent index values (e.g., marketed as a “College Popularity Ranking Index”) indicate that College X's index value has dropped relative to its index value from last year and also relative to the current index values for other schools in the Big 10. In this example, the index is based on transactional spend of college tour/campus store spend, application fee, and admissions deposit. College X may respond to this indication of reduced interest by relaxing its admission standards in order to accept more students from its applicant pool. Meanwhile, a prospective student may see the reduced index of College X as a great opportunity to apply to the college, predicting that College X will be likely to relax its admission standards and thus enable the student to fulfill a life-long dream of attending the college.

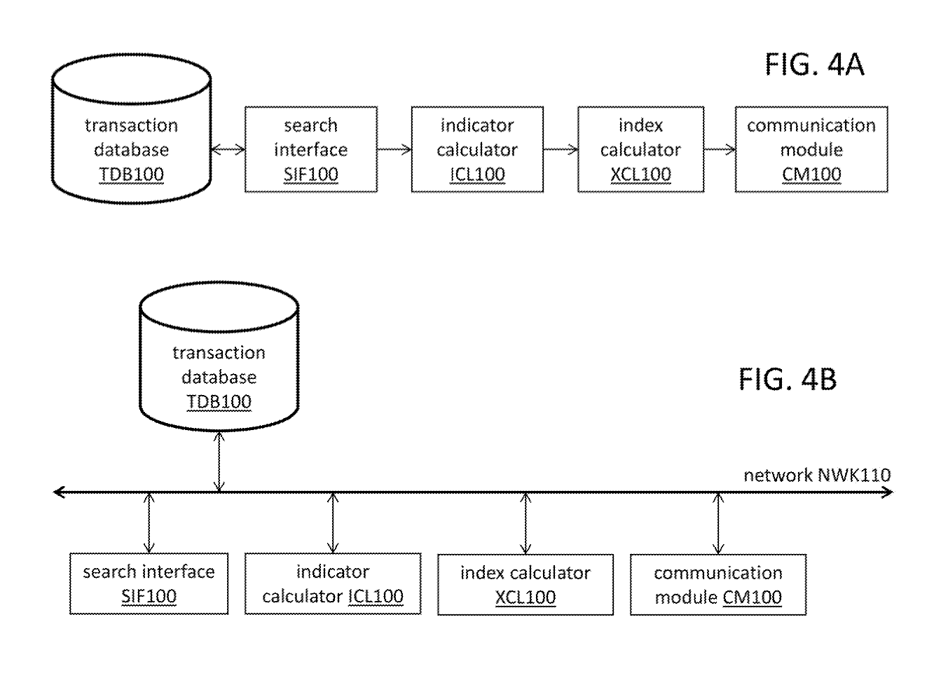

FIG. 4A shows a block diagram of an apparatus A100 for using data from recent purchase transactions to indicate a comparative level of current interest for each among a number of colleges. For example, apparatus A100 may be configured to perform an implementation of method M100 as described herein.

Apparatus A100 includes a transaction database TDB100, a search interface SIF100, an interest indicator calculator ICL100, an index calculator XCL100, and a communication module CM100. Apparatus A100 may be implemented such that all of these elements (or all of elements SIF100, ICL100, XCL100, and CM100) are implemented by the same personal computer, workstation, or server. Alternatively, apparatus A100 may be implemented such that storage and/or processing of one or more such elements is cloud-based or otherwise distributed (e.g., among two or more servers) across a network. FIG. 4B shows an example of a system implementation of apparatus A100 in which communication among the various elements occurs over a network NWK110. Examples of such a network include Transmission Control Protocol/Internet Protocol (TCP/IP), Ethernet, Fiber Distributed Data Interface (FDDI), token bus, and token ring networks.

Transaction database TDB100 is configured to store a plurality of records of consumer purchase transactions (e.g., as described herein with reference to task T100). It is noted that database TDB100 may be implemented as one or more data structures, which may be stored in different physical locations. Specifically, different data fields of an entry of the database may be stored in different physical locations.

Search interface SIF100 is configured to identify, from among the stored plurality of records and for each of a plurality of colleges, records that are associated with the college (e.g., as described herein with reference to task T100). Interest indicator calculator ICL100 is configured to calculate, for each of the plurality of colleges and for each of a plurality of interest indicators, a value of the interest indicator for the college (e.g., as described herein with reference to task T200). Interest indicator calculator ICL100 is configured to calculate each of the interest indicator values based on information from the records identified for the college by search interface SIF100. Index calculator XCL100 is configured to produce, for each of the plurality of colleges, a value of an index for the college that is based on (A) the calculated at least one interest indicator value for the college and (B) the calculated at least one interest indicator value for each of at least one other college among the plurality of colleges (e.g., as described herein with reference to task T300). Communication module CM100 is configured to transmit an indication relating to at least one of the produced index values (e.g., as described above with reference to task T400). Module CM100 may be configured to transmit the indication electronically, such as by e-mail and/or SMS. Module CM100 may also be configured to generate a printed document that includes the indication (e.g., for delivery via mail or other delivery service). In a further example, module CM100 may be configured to transmit the indication in response to a query, such as via SMS or over the Internet (e.g., via the Hypertext Transfer Protocol (HTTP) or another protocol).

Apparatus A100 may be implemented in any combination of hardware with software, and/or with firmware, that is deemed suitable for the intended application. It is noted that any of the various implementations of method M100 disclosed herein may be performed by one or more processors. The implementations of methods, schemes, and techniques as disclosed herein may also be embodied, in one or more computer-readable storage media, as one or more sets of instructions readable and/or executable by one or more processors, such that the instructions cause one or more processors executing the instructions to perform the acts of such a method as disclosed herein. Such a storage medium may be a conventional read/write memory such as a magnetic disk, floppy disk, optical disc, compact-disc read-only-memory (CD-ROM), digital versatile disc (DVD), Blu-ray Disc™, magneto-optical storage, flash memory, random-access memory, transistor-based memory, magnetic tape, and/or any other non-transitory computer-readable memory device as is known in the art for storing and retrieving data. Significantly, such computer-readable storage media may be remotely located from such one or more processors and may be connected to such one or more processors via a network such as a local area network (LAN), a wide area network (WAN), or the Internet.

It is understood by those known in the art that instructions for such method embodiments may be stored on their respective computer-readable memory and executed by their respective processors. It is understood by those skilled in the art that other equivalent implementations can exist without departing from the spirit or claims of the invention.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A method of using data from recent purchase transactions to indicate a comparative level of current interest for each among a number of colleges, said method comprising:
from among a plurality of records of consumer purchase transactions, identifying, for each of a plurality of colleges, records that are associated with the college;
for each of the plurality of colleges, and for each of a plurality of interest indicators, calculating a value of said interest indicator for the college, wherein said value is based on information from the records identified for the college;
for each of the plurality of colleges, producing a value of an index for the college that is based on (A) the calculated interest indicator values for the college and (B) the calculated interest indicator values for each of at least one other college among the plurality of colleges; and
subsequent to said producing, transmitting an indication relating to at least one of the produced index values.

2. The method according to claim 1, wherein said producing the index value comprises, for each of the plurality of colleges, comparing said calculated value of at least one interest indicator for the college to a previous value of the at least one interest indicator for the college to produce the index value for the college, and
wherein said index value is based on a result of said comparing.

3. The method according to claim 1, wherein for at least one among the plurality of colleges, at least one among said calculated interest indicator values is based on information from records, from among said plurality of records, that identify the college as the merchant.

4. The method according to claim 1, wherein said plurality of records includes records that identify, for at least one among the plurality of colleges, the college as a merchant, and
wherein for said at least one among the plurality of colleges, said identifying records comprises distinguishing, from among said records that identify the college as a merchant, a plurality of records which each indicate a purchase amount that satisfies a predetermined range, and
wherein for said at least one among the plurality of colleges, at least one among said calculated interest indicator values is based on information from a plurality of records that is limited to, from among said records that identify the college as the merchant, said distinguished records.

5. The method according to claim 1, wherein said plurality of records includes a plurality of records that include merchant location information, and
wherein for at least one among said plurality of colleges, said identifying records that are associated with the college includes identifying records based on said merchant location information.

6. The method according to claim 1, wherein said calculating the value of the interest indicator comprises:
calculating a value of a measure of interest in the college that is based on information from the records identified for the college that correspond to transactions that occurred within a first time period; and
calculating the value of the interest indicator as a relation between (A) said calculated value of the measure and (B) a value of the measure that is based on information corresponding to transactions that occurred within a time period that is prior to said first time period.

7. The method according to claim 1, wherein for at least one among the plurality of colleges, said producing the index value is performed on a first date, and
wherein said method comprises, for said at least one among the plurality of colleges, and for at least one among said plurality of interest indicators, calculating a second value of each of said at least one interest indicator for the college, wherein said second value is based on information from records of consumer purchase transactions that occurred after said first date, and
wherein said method comprises, for said at least one among the plurality of colleges, and on a second date that is not less than one week and not more than four months subsequent to said first date, producing a second value of said index for the college that is based on said calculated second value of each of said at least one interest indicator for the college.

8. An apparatus for using data from recent purchase transactions to indicate a comparative level of current interest for each among a number of colleges, said apparatus comprising:
a transaction database configured to store a plurality of records of consumer purchase transactions;
a search interface configured to identify, from among the plurality of records of consumer purchase transactions, and for each of a plurality of colleges, records that are associated with the college;
an indicator calculator configured to calculate, for each of the plurality of colleges, and for each of a plurality of interest indicators, a value of said interest indicator for the college, wherein said value is based on information from the records identified for the college;
an index calculator configured to produce, for each of the plurality of colleges, a value of an index for the college that is based on (A) the calculated at least one interest indicator value for the college and (B) the calculated at least one interest indicator value for each of at least one other college among the plurality of colleges; and
a communication module configured to transmit an indication relating to at least one of the produced index values.

9. The apparatus according to claim 8, wherein said index calculator is configured to compare, for each of the plurality of colleges, said calculated value of at least one interest indicator for the college to a previous value of the at least one interest indicator for the college to produce the index value for the college, and
wherein said index value is based on a result of said comparing.

10. The apparatus according to claim 8, wherein for at least one among the plurality of colleges, at least one among said calculated interest indicator values is based on information from records, from among said plurality of records, that identify the college as the merchant.

11. The apparatus according to claim 8, wherein said plurality of records includes records that identify, for at least one among the plurality of colleges, the college as a merchant, and
wherein for said at least one among the plurality of colleges, said search interface is configured to distinguish, from among said records that identify the college as a merchant, a plurality of records which each indicate a purchase amount that satisfies a predetermined range, and
wherein for said at least one among the plurality of colleges, at least one among said calculated interest indicator values is based on information from a plurality of records that is limited to, from among said records that identify the college as the merchant, said distinguished records.

12. The apparatus according to claim 8, wherein said plurality of records includes a plurality of records that include merchant location information, and
wherein for at least one among said plurality of colleges, said search interface is configured to identify records that are associated with the college by identifying records based on said merchant location information.

13. The apparatus according to claim 8, wherein said indicator calculator is configured to:
calculate a value of a measure of interest in the college that is based on information from the records identified for the college that correspond to transactions that occurred within a first time period; and
calculate the value of the interest indicator as a relation between (A) said calculated value of the measure and (B) a value of the measure that is based on information corresponding to transactions that occurred within a time period that is prior to said first time period.

14. The apparatus according to claim 8, wherein for at least one among the plurality of colleges, said index calculator is configured to produce the index value on a first date, and
wherein said indicator calculator is configured to calculate, for said at least one among the plurality of colleges, and for at least one among said plurality of interest indicators, a second value of each of said at least one interest indicator for the college, wherein said second value is based on information from records of consumer purchase transactions that occurred after said first date, and
wherein said index calculator is configured to produce, for said at least one among the plurality of colleges, and on a second date that is not less than one week and not more than four months subsequent to said first date, a second value of said index for the college that is based on said calculated second value of each of said at least one interest indicator for the college.

15. A non-transitory computer-readable medium encoded with data and instructions, when executed by at least one processor the instructions causing the at least one processor to:
identify, from among a plurality of records of consumer purchase transactions, and for each of a plurality of colleges, records that are associated with the college;
calculate, for each of the plurality of colleges, and for each of a plurality of interest indicators, a value of said interest indicator for the college, wherein said value is based on information from the records identified for the college;
produce, for each of the plurality of colleges, a value of an index for the college that is based on (A) the calculated at least one interest indicator value for the college and (B) the calculated at least one interest indicator value for each of at least one other college among the plurality of colleges; and
subsequent to said producing, transmit an indication relating to at least one of the produced index values.

16. The non-transitory computer-readable medium of claim 15, wherein said producing the index value comprises, for each of the plurality of colleges, comparing said calculated value of at least one interest indicator for the college to a previous value of the at least one interest indicator for the college to produce the index value for the college, and
wherein said index value is based on a result of said comparing.

17. The non-transitory computer-readable medium of claim 15, wherein for at least one among the plurality of colleges, at least one among said calculated interest indicator values is based on information from records, from among said plurality of records, that identify the college as the merchant.

18. The non-transitory computer-readable medium of claim 15, wherein said plurality of records includes records that identify, for at least one among the plurality of colleges, the college as a merchant, and
wherein for said at least one among the plurality of colleges, said identifying records comprises distinguishing, from among said records that identify the college as a merchant, a plurality of records which each indicate a purchase amount that satisfies a predetermined range, and
wherein for said at least one among the plurality of colleges, at least one among said calculated interest indicator values is based on information from a plurality of records that is limited to, from among said records that identify the college as the merchant, said distinguished records.

19. The non-transitory computer-readable medium of claim 15, wherein said plurality of records includes a plurality of records that include merchant location information, and
wherein for at least one among said plurality of colleges, said identifying records that are associated with the college includes identifying records based on said merchant location information.

20. The non-transitory computer-readable medium of claim 15, wherein said calculating the value of the interest indicator comprises:
calculating a value of a measure of interest in the college that is based on information from the records identified for the college that correspond to transactions that occurred within a first time period; and
calculating the value of the interest indicator as a relation between (A) said calculated value of the measure and (B) a value of the measure that is based on information corresponding to transactions that occurred within a time period that is prior to said first time period.
